(19) United States
(12) Patent Application Publication
(10) Pub. No.: US 2014/0061067 A1
(43) Pub. Date: Mar. 6, 2014

(54) CHILD RESISTANT PACKAGING SYSTEM

(71) Applicant: MeadWestvaco Corporation, Richmond, VA (US)

(72) Inventor: John A. GELARDI, Midlothian, VA (US)

(21) Appl. No.: 14/077,298

(22) Filed: Nov. 12, 2013

Related U.S. Application Data
(63) Continuation of application No. 13/510,959, filed on May 21, 2012, now abandoned.
(60) Provisional application No. 61/287,960, filed on Dec. 18, 2009.

(51) Int. Cl. B65D 50/04; A61J 1/03; B65D 77/04

(52) U.S. Cl. CPC B65D 50/046; B65D 77/04; A61J 1/035
USPC 206/1.5

(57) ABSTRACT

A packaging system includes an outer shell and a sliding member. The sliding member is disposed in the interior chamber of the outer shell such that the sliding member is movable between a locked position where one end of the sliding member is near the closed end of the outer shell and a withdrawn position where the one end of the sliding member is near the open end of the outer shell. The sliding member has a locking edge which abuts a locking portion of the outer shell when the sliding member is at the locked position such that the sliding member is prevented from moving toward the withdrawn position. The outer shell has an area that is deflected inward of the interior chamber upon application of pressure thereto such that the locking edge of the sliding member clears the locking portion of the outer shell. The area is not defined by any visible boundaries.

### BACKGROUND

The present invention relates generally to a locking container that may be child resistant where multiple movements are required to open the package and control the dispensing of medication.

Locking caps on medicine bottles are well known. Locking tray systems have also been taught as shown in U.S. Pat. No. 7,591,372. Multiple tray systems also have value for bulk prescriptions or for am/pm combination medications.

A need exists for an easily assembled and easily fillable multi-blister pack that may have child resistant features for use with medications, food, tobacco products or other such products.

### SUMMARY OF THE INVENTION

Disclosed is a package or packaging system comprising a top cover and a bottom cover, which may form an outer shell, and a sled. The top cover may include a top surface and a side wall defining an open end and a closed end, while the bottom cover may include a bottom surface and a side wall defining a corresponding open end and a closed end. The bottom cover may further include a sled lock positioned along the side wall near the closed end of the bottom cover and a sled rail extending substantially the length of the bottom surface. The sled lock includes a ramped surface facing the open end of the bottom cover and a flat vertical surface facing the closed end of the bottom cover. It is to be understood that the sled lock, sled rail or portions thereof may be adjusted to be located on the top cover based on manufacturing preferences.

The sled is adapted to sit between the top and bottom cover when the packaging system is assembled. The sled includes a leading edge and a trailing edge and a dagger capable of receiving and retaining an insert card. The top cover attaches to the bottom cover to define an interior chamber in which the sled can slide along the sled rail. The leading edge of the sled will ride up and over the ramped surface of the sled lock until the trailing edge of the sled clears the sled stop causing the sled to be locked into place. Pressure applied to the top and bottom covers proximate to where the sled is positioned will cause the sled to deflect inward and result in the trailing edge of the sled clearing the sled lock. Based on manufacturing preferences, the sled and shell may be adjusted such that pressure may be applied from the sides of the top and bottom covers as well to move the sled.

The packaging system can also include a hinged end cover attached along the edge of the open end of the top and/or bottom cover. The top cover further may comprise a sled containment ridge positioned along the top surface and extending substantially the length of the open end that functions to prevent the sled from being completely withdrawn from within the interior chamber by abutting the trailing edge of the sled. It is to be understood that manufacturing preferences may adjust the sled containment ridge to be positioned on the bottom cover.

The sled is adapted to receive an insert card that includes a strategically positioned aperture adapted to hook over and be retained by the at least one dagger.

### BRIEF DESCRIPTION OF THE DRAWINGS

FIG. 1 is an illustration of a bottom cover and sled in an unlocked position of a packaging system according to an embodiment of the invention.

FIG. 2 is an illustration of a bottom cover and sled in a locked position of a packaging system according to an embodiment of the invention.

FIG. 3 is a partial cross-sectional illustration of an assembled packaging system having the sled in its locked position according to an embodiment of the invention.

FIG. 4 is an illustration of an assembled packaging system having the sled in its unlocked position further showing a plurality of insert cards attached to the sled according to an embodiment of the invention.

FIG. 5 is a partial cross-sectional illustration of an assembled paperboard packaging system having the sled in its unlocked position according to an embodiment of the invention.

### DETAILED DESCRIPTION OF THE PREFERRED EMBODIMENTS

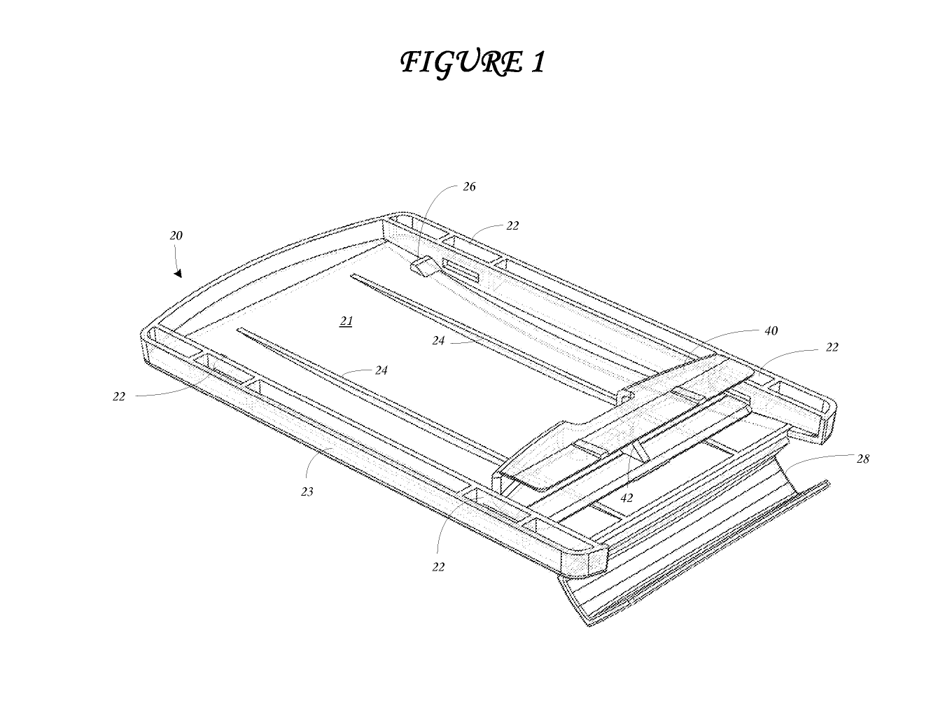

FIG. 1 is an illustration of a bottom cover 20 and sled 40 in an unlocked position of a package or packaging system 10 according to an embodiment of the invention. The bottom cover 20 includes a bottom surface 21 and a side wall 23 that defines an open end and a closed end. The bottom cover 20 is adapted to mate with a top cover 30 to form the packaging system 10 in which an interior chamber is defined. There are a plurality of tab receptacles 22 that are adapted to receive a corresponding plurality of tabs 32 of the top cover 30 in a snap-fit configuration. Other means of connecting the top cover 30 with the bottom cover 20 can be used such as an adhesive material. Furthermore the bottom cover 20 may be hingidly connected to the top cover 30 in a book style configuration. The bottom surface 21 has at least one sled rail 24 that provides a generally flat surface for a generally C-shaped sled 40 to ride along within the interior chamber of the assembled packaging system 10. Also included is at least one sled lock 26 positioned along one or more side walls 23 near the closed end of the bottom cover 20. A hinged end cover 28 is connected along the open end of the bottom cover 20 and provides access to the interior chamber when the packaging system 10 is assembled. The hinged end cover 28 can fold up over and couples with a portion of top cover 30 to seal the interior chamber. It is to be understood that based on manufacturing preferences the features mentioned in this paragraph could be placed on the top cover.

A sled 40 is shown positioned near the open end of the bottom cover 20 resting on the at least one sled rail 24. This is considered the unlocked position since the sled 40 can slide freely along the at least one sled rail 24. The sled includes a sled dagger feature that is used to couple with at least one insert card 50. The insert card 50 contains the contents of the packaging system 10 and can take multiple forms including, but not limited to, blister type packaging or tray type packaging.

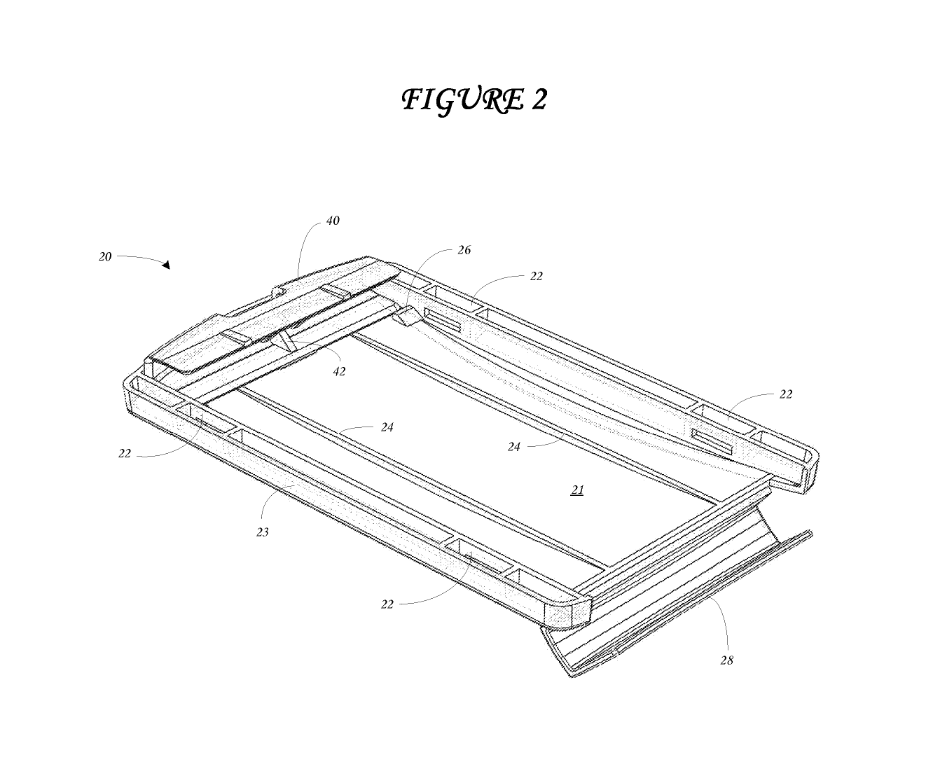

FIG. 2 is an illustration of a bottom cover 20 and sled 40 in a locked position of a packaging system 10 according to an embodiment of the invention. This illustration is the same as FIG. 1 except that the sled 40 is now in its locked position tucked behind the at least one sled lock 26. The at least one sled lock 26 includes a ramped vertical surface facing the open end of bottom cover 20 and a flat vertical surface facing the facing the closed end of bottom cover 20. This configuration allows the leading edge of sled 40 to ascend up and over the ramped vertical surface of the at least one sled lock 26. Once the trailing edge of sled 40 clears the at least one sled lock 26 it becomes fixed in place due to the trailing edge of sled 40 abutting the flat vertical surface of the at least one sled lock 26. The sled 40 cannot move back out until the user applies a force on the packaging system 10 sufficient to cause the trailing edge of sled 40 to clear the flat vertical surface of the at least one sled lock 26. This unlocking step is described in more detail later.

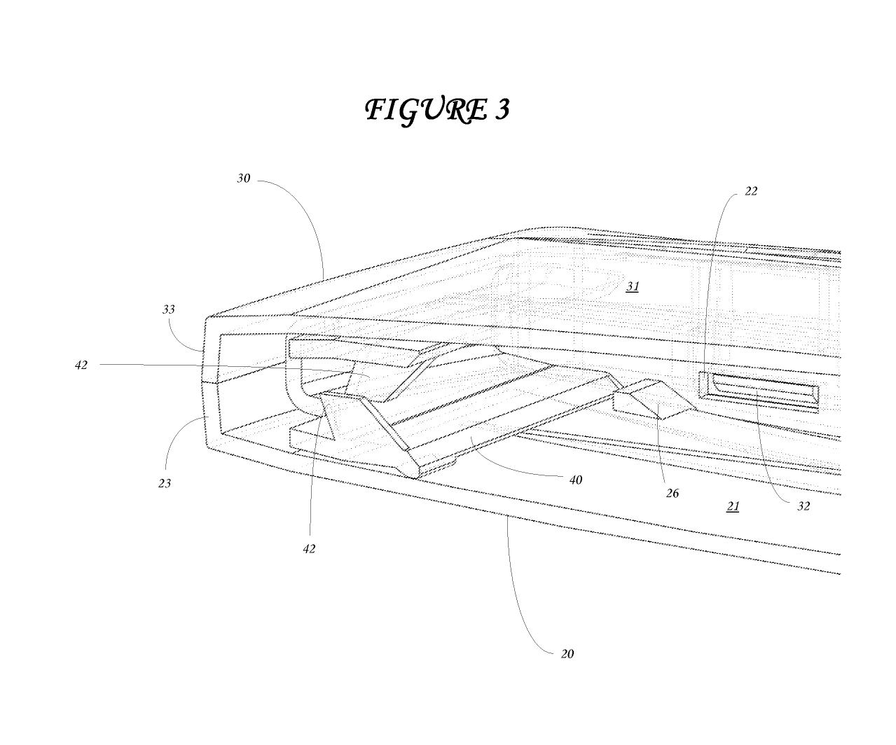

FIG. 3 is a partial cross-sectional illustration of an assembled packaging system 10 having the sled 40 in its locked position according to an embodiment of the invention. This illustration provides a close up view of the sled 40 in the locked position tucked behind the at least one sled lock 26. A plurality of sled daggers 42 are shown. The one or more sled daggers 42 each angle back. One may protrudes up from the bottom the sled 40 while one may protrude down from the top of the sled 40. These one or more sled daggers 42 may work in concert to receive and retain at least one insert card 50 wherein the insert card 50 includes a strategically positioned aperture that corresponds with the sled daggers 42.

The top cover 30 is similar in construction to the bottom cover 20 in that it also includes a top surface 31 and a side wall 33 that defines an open end and a closed end. The top cover 30 and bottom cover 20 are joined together in this embodiment using a snap-fit type coupling. A cover tab 32 is shown inserted within and retained by a tab receptacle 22. It should be noted that the cover tabs 32 and the tab receptacles 22 can be inverted such that the cover tabs are present on the bottom cover while the tab receptacles are present on the top cover. Other such couplings can be found about the perimeter of the packaging system 10 to ensure a sufficient connection.

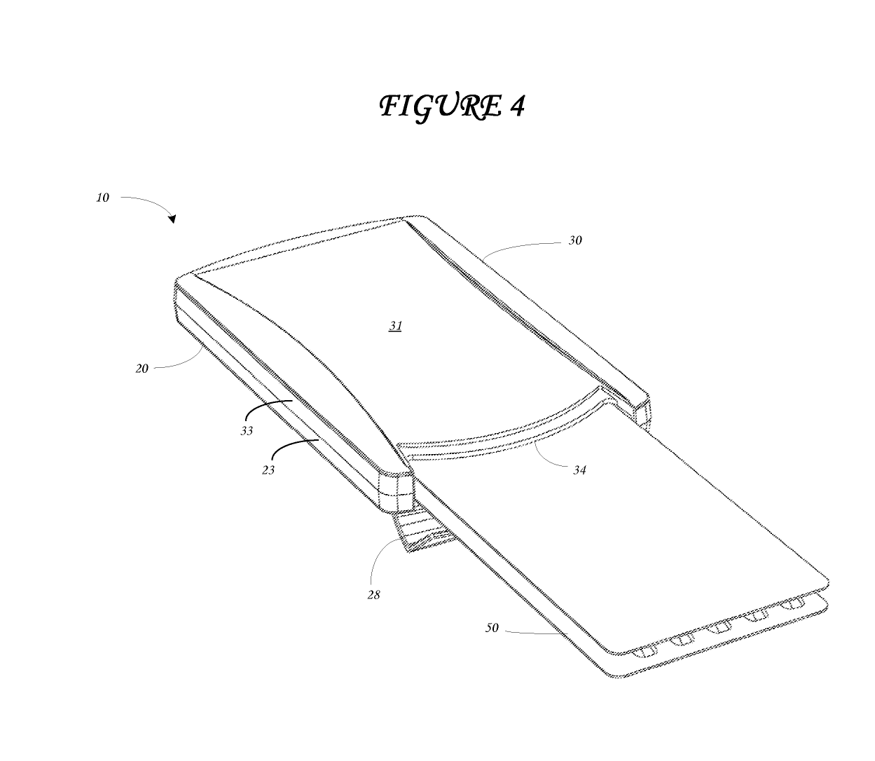

FIG. 4 is an illustration of an assembled packaging system 10 having the sled 40 in its unlocked position further showing a plurality of insert cards 50 attached to the sled 40 according to an embodiment of the invention. The top cover 30 and bottom cover 20 are coupled with the hinged end cover 28 open. A plurality of insert cards 50 are coupled to a sled 40 (hidden from view) that is resting on sled rails 24 (hidden from view). The top cover 30 further includes a sled containment ridge 34 that runs along the open end of top cover 30. The sled containment ridge 34 serves a dual purpose. A first function is to ensure that the sled 40 can not be completely withdrawn from the interior chamber of the packaging system 10. This is achieved because the sled containment ridge 34 extends below the surface 31 of top cover 30. If a user attempts to withdraw the sled 40 by pulling the insert cards 50, the top trailing edge of the sled will encounter and abut the sled containment ridge 34 preventing sled 40 from coming out of the interior chamber. A second function for sled containment ridge 34 is to provide a coupling point with the hinged end cover 28 of the bottom cover 20. When sled 40 and insert cards 50 are fully inserted within the interior chamber and locked behind the at least one sled lock 26, the hinged end cover 28 can be rotated about its hinged axis and rest upon the upper surface of the sled containment ridge 34 thereby sealing the sled 40 and insert cards 50 within the packaging system 10.

To assemble the packaging system 10, sled 40 is placed atop the at least on sled rail 24 that are formed on the surface 21 of the bottom cover 20. The top cover 30 is then fit atop the bottom cover 20 and snapped into place using the plurality of cover tabs 32 and tab receptacles 22. Alternatively, the top cover 30 and the bottom cover 20 can also be coupled in a different manner such as, for instance, via an adhesive material. In addition, the top and bottom could be hinged such that the two sides may be folded together to form a sealed outer shell. One or more insert cards 50 can be inserted into the open end of the packaging system 10 until the insert cards 50 encounter and hook over the sled dagger(s) 42. It is also possible for the insert cards 50 to be attached to sled 40 before the top cover 30 and bottom cover 20 are coupled if preferred.

Once the packaging system 10 is assembled, a user can push the insert cards 50 into the interior chamber causing the leading edge of sled 40 to ride up the ramped surface of the at least one sled lock 26 until the sled 40 clears the at least one sled lock 26 and becomes fixed in place.

To release sled 40 from its locked position, a user applies a pinching pressure on the top cover 30 and the bottom cover 20 in an area proximate to the location of the sled 40. This area can be on the top, bottom and/or sides of the outer shell. The top cover 30 and bottom cover 20 will deflect inward and contact the surfaces of the generally C-shaped sled 40. Continued pressure will cause the trailing edges of sled 40 to deflect inward until the sled's bottom trailing edge clears the at least one sled lock 26. This effort combined with the user gently grasping and pulling on the insert cards 50 once sled 40 clears the at least one sled lock 26 will allow sled 40 to ride along at least one sled rail 24 further removing and exposing the insert cards 50. The insert cards can be fully withdrawn while the sled remains trapped within the interior chamber since the trailing edge of sled 40 cannot clear the one or more sled containment ridge(s) 34.

The design and construction of the packaging system 10 is not dependent on a specific unlocking tab feature to release the sled from its locked position. Rather, a user need only pinch in a generalized area proximate to the sled's location to cause a deflection sufficient to clear the at least one sled lock 26.

The materials that comprise the main components of the packaging system 10 can vary so long as they maintain sufficient flexibility and rigidity to perform the functions described and attributed to them herein.

The outer shell may be composed of paper board or a paperboard like substrate and may be folded into an outer shell shape from a cut out die. The paperboard outer shell may have am open end and a closed end. The board may be treated to be tear resistant, water resistant, to have better printing features and/or to add other benefits to the material. The outer shell could be wrapped in shrink film to provide additional barrier or printing benefits. In such a package the locking and retaining features may be adhered or attached to the interior of the paperboard outer shell. For example, at least one sled rail 24 could be attached to the bottom and/or top of the paperboard shell such that the sled can slide along the at least one sled rail 24. At least one sled lock 26 may be attached to the top and/or bottom of the paperboard package in a location similar to that describes in the prior versions of the package. The sled lock may be attached closer to the closed end of the package; it may be attached to the last third of the package closer to the closed end; it may be attached to the second half of the package. The sled element may be similar to the sled in the plastic shell package. A sled containment ridge 40 may be attached or built-in to the outer paperboard shell. This ridge 40 may be placed in the front third of the package; this ridge 40 may be placed adjacent to or as a portion of the open end of the package.

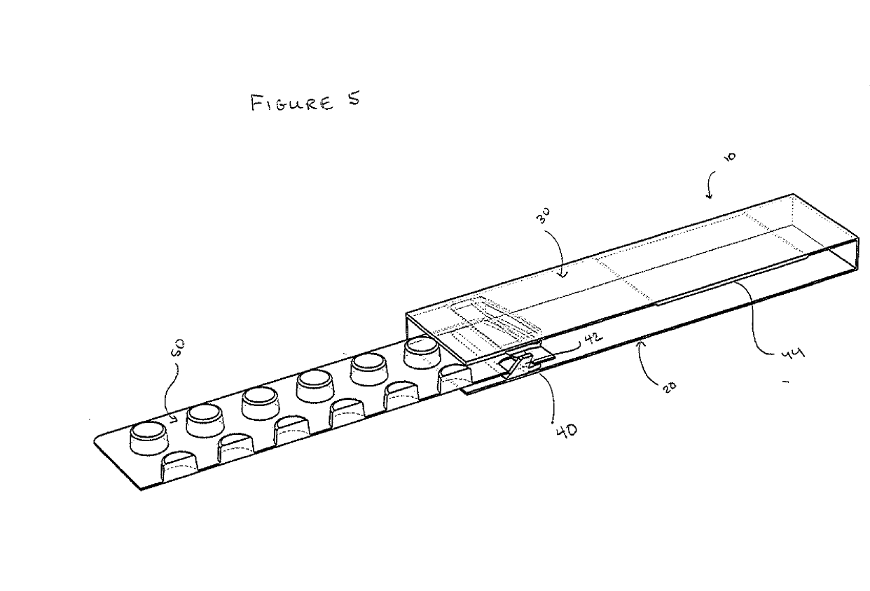

FIG. 5 is a partial cross-sectional illustration of an assembled packaging system 10 having the sled 40 in its unlocked position according to an embodiment of the invention and having the outer shell being comprised of paperboard material. The paperboard may be treated or untreated. The paperboard may be tear resistant. The outer shell may be folder and sealed to form a six sided rectangle with one or more open ends. The outer shell may have a locking ledge 44 formed on the inside by an extra panel. The outer shell may also have locks and retaining features attached to it. Such features may be paperboard or plastic or any other suitable materials. This illustration provides a close up view of the sled 40 in the unlocked position. A sled dagger 42 is shown. The one or more sled daggers 42 angles back away from the open side of the outer shell. These one or more sled daggers 42 may work in concert to receive and retain at least one insert card 50 wherein the insert card 50 includes a strategically positioned aperture that corresponds with the one or more sled daggers 42. The sled may be made of plastic or any other suitable material. An unlocking feature to allow the sled to move past the locking ledge or locking element 44 may be placed on the sides, top, bottom or any combination of the package. The unlocking element may be a pressure area or a push tab area and may be proximate to the locking element. The unlocking element may be in the same third of the package as the locking element. The unlocking element may be in the same half of the package as the locking element.

It is to be understood that the pinch pressure may be applied to the top and bottom of the package or on the sides or any combination of the above based on manufacturing preferences.

This disclosure should not be read as being limited only to the foregoing examples or only to the designated preferred embodiments.

1-14. (canceled)

15. A package comprising:
an outer shell having:
a top;
a bottom;
two sides;
a closed end; and
an open end,
wherein the top, bottom and two sides define an interior chamber, one of the top and bottom being provided with at least one locking portion;
a sliding member disposed in the interior chamber of the outer shell such that the sliding member is movable between a locked position where one end of the sliding member is near the closed end of the outer shell and a withdrawn position where the one end of the sliding member is near the open end of the outer shell, the sliding member comprising a locking edge which abuts the at least one locking portion of the outer shell when the sliding member is moved to the locked position such that the sliding member when at the locked position is prevented from moving toward the withdrawn position, and wherein the sliding member comprises at least one insert card, the at least one insert card having a planar surface and being disposed within the interior chamber when the sliding member is at the locked position, the planar surface of the at least one insert card facing the one of the top and bottom of the outer shell when the sliding member is at the locked position,
wherein the one of the top and bottom of the outer shell comprises an area proximate to the closed end of the outer shell and disposed above the planar surface of the at least one insert card, the area being deflected inward of the interior chamber upon application of pressure thereto such that the locking edge of the sliding member clears the at least one locking portion, wherein the area is not defined by any visible boundaries.

16. A package comprising:
an outer shell having:
a top;
a bottom;
two sides;
a closed end; and
an open end,
wherein the top, bottom and two sides define an interior chamber, one of the top and bottom being provided with at least one locking portion;
a sliding member disposed in the interior chamber of the outer shell such that the sliding member is movable between a locked position where one end of the sliding member is near the closed end of the outer shell and a withdrawn position where the one end of the sliding member is near the open end of the outer shell, the sliding member comprising a locking edge which abuts the at least one locking portion of the outer shell when the sliding member is at the locked position such that the sliding member when at the locked position is prevented from moving toward the withdrawn position, and wherein the sliding member comprises at least one insert card, the at least one insert card having a planar surface and being disposed within the interior chamber when the sliding member is at the locked position, the planar surface of the at least one insert card facing the one of the top and bottom of the outer shell when the sliding member is at the locked position,
wherein the one of the top and bottom of the outer shell comprises an area proximate to the closed end of the outer shell and disposed above the planar surface of the at least one insert card, the area being deflected inward of the interior chamber upon application of pressure thereto such that the locking edge of the sliding member clears the at least one locking portion, wherein the area is not visually distinguishable from the remainder of the one of the top and bottom of the outer shell.

17. The package of claim 15, wherein the area of the one of the top and bottom of the outer shell is integral with the one of the top and bottom of the outer shell.

18. The package of claim 15, wherein the sliding member has at least one ramped surface.

19. The package of claim 15, wherein the sliding member can slide along the one of the top and bottom of the outer shell such that the locking edge of the sliding member, when moving toward the locked position, will slide until the locking edge of the sliding member clears the at least one locking portion.

20. The package of claim 15, wherein the outer shell further comprises a sliding member containment ridge that extends substantially the length of the open end of the outer shell and functions to prevent the sliding member from being completely withdrawn from the interior chamber by abutting the locking edge of the sliding member.

21. The package of claim 15, wherein the outer shell is composed of paperboard.

22. The package of claim 21, wherein the outer shell further comprises a sliding member containment ridge built-in to the outer shell, the containment ridge serving to prevent the sliding member from being completely withdrawn from the interior chamber by abutting the locking edge of the sliding member.

23. The package of claim 16, wherein the area of the one of the top and bottom of the outer shell is integral with the one of the top and bottom of the outer shell.

24. The package of claim 16, wherein the sliding member has at least one ramped surface.

25. The package of claim 16, wherein the sliding member can slide along the one of the top and bottom of the outer shell such that the locking edge of the sliding member, when moving toward the locked position, will slide until the locking edge of the sliding member clears the at least one locking portion.

26. The package of claim 16, wherein the outer shell further comprises a sliding member containment ridge that extends substantially the length of the open end of the outer shell and functions to prevent the sliding member from being completely withdrawn from the interior chamber by abutting the locking edge of the sliding member.

27. The package of claim 16, wherein the outer shell is composed of paperboard.

28. The package of claim 27, wherein the outer shell further comprises a sliding member containment ridge built-in to the outer shell, the containment ridge serving to prevent the sliding member from being completely withdrawn from the interior chamber by abutting the locking edge of the sliding member.

29. A package comprising:
an outer shell having:
a top;
a bottom;
two sides;
a closed end; and
an open end,
wherein the top, bottom and two sides define an interior chamber, one of the top and bottom being provided with a locking portion in the interior chamber;
the interior chamber being configured to house a sliding member such that the sliding member is movable between a locked position in which one end of the sliding member is near the closed end of the outer shell and a withdrawn position in which the one end of the sliding member is near the open end of the outer shell, the locking portion configured to retain the sliding member in the locked position such that the sliding member when at the locked position is prevented from moving toward the withdrawn position,
wherein the locking portion of the one of the top and bottom of the outer shell is configured to be deflected inward of the interior chamber upon application of pressure to an area of the one of the top and bottom of the outer shell such that the locking portion disengages from the sliding member thereby allowing the sliding member to move toward the withdrawn position, wherein the area of the one of the top and bottom of the outer shell is not visually distinguishable from a remainder of the outer shell.

30. The package of claim 29, wherein the sliding member comprises at least one insert card has a planar surface, and the insert card is disposed within the interior chamber when the sliding member is at the locked position, the planar surface of the at least one insert card facing the one of the top and bottom of the outer shell when the sliding member is within the outer shell, and the locking portion is disposed above the planar surface of the at least one insert card when the sliding member is within the outer shell.
